(19) United States
(12) Patent Application Publication
(10) Pub. No.: US 2025/0133389 A1
(43) Pub. Date: Apr. 24, 2025

(54) FRAMEWORK FOR SUPPORT OF LIMITED-FUNCTION INTERNET-OF-THINGS (IOT) WIRELESS DEVICES

(71) Applicant: Cypress Semiconductor Corporation, San Jose, CA (US)

(72) Inventors: Rakesh Taori, McKinney, TX (US); Kiran Uln, Pleasanton, CA (US); Hemamali Gorthi, Bengaluru (IN); Suprojit Mukherjee, Nadia (IN)

(73) Assignee: Cypress Semiconductor Corporation, San Jose, CA (US)

(21) Appl. No.: 18/414,985

(22) Filed: Jan. 17, 2024

Related U.S. Application Data
(60) Provisional application No. 63/591,405, filed on Oct. 18, 2023.

(51) Int. Cl. H04W 8/22; H04B 7/06; H04L 1/00; H04L 5/00

(52) U.S. Cl. CPC H04W 8/22; H04B 7/0617; H04L 1/0003; H04L 5/0094

(57) ABSTRACT

A wireless device includes a front end and a processor coupled to the front end. The processor is to initiate, via the front end, association of the wireless device with an anchor wireless device to communicate with the anchor wireless device. The processor is further to cause the front end to transmit, to the anchor wireless device, management frames including a plurality of bits that specify physical layer (PHY) capabilities. The plurality of bits includes a particular bit that indicates whether the wireless device is an Internet-of-things (IoT) device.

### CLAIM OF PRIORITY

The present application claims the benefit under 35 U.S.C. § 119 (e) of U.S. Provisional Patent Application No. 63/591,405 filed Oct. 18, 2023, which is incorporated by this reference herein.

### TECHNICAL FIELD

This disclosure relates to wireless devices and, more specifically, to a framework for support of limited-function Internet-of-Things (IoT) wireless devices.

### BACKGROUND

In current wireless standards that provide for Medium Access Control (MAC) and Physical Layer (PHY) specifications, there is no way for a Wi-Fi® station (STA) to signal that the STA is of a limited capability, such as an IoT device, or whether a STA can support certain features such as Multi-Resource Unit (MR-U) or beamforming. Some features may be particular to or only able to be handled by regular STAs, for example. Without the ability to discern between types of STAs (e.g., IoT versus regular), an anchor wireless device (such as an access point, router, or the like) cannot know how to most-efficiently interact with STAs of different capabilities. For example, either an entire feature set is available to a given STA or no feature in that feature set is available to the STA.

### BRIEF DESCRIPTION OF THE DRAWINGS

FIG. 1 is a block diagram of a wireless network that includes an example client wireless device of limited capability, such as an IoT wireless device, according to various embodiments.

FIG. 2 is a block diagram of exemplary mapping of multiple bits of management frames to be transmitted to an anchor wireless device to communicate feature set capability according to some embodiments.

FIG. 3 is a flow chart of a method for a client wireless device to communicate to the anchor wireless device that the client wireless device is an IoT wireless device according to an embodiment.

FIG. 4 is a block diagram of a wireless network including an exemplary anchor wireless device that communicates with different types of client wireless devices according to some embodiments.

FIG. 5 is a flow chart of a method for an anchor wireless device to receive indication for the client wireless device that the client wireless device is an IoT wireless device according to some embodiments.

### DETAILED DESCRIPTION

The following description sets forth numerous specific details such as examples of specific systems, devices, components, methods, and so forth, in order to provide a good understanding of various embodiments of a framework support of limited-function wireless Internet-of-things (IoT) devices, e.g., lite-weight devices. As discussed previously, in current Wi-Fi® standards that provide for MAC and PHY specifications, there is no way for a Wi-Fi® station (STA) to signal that the STA is of a limited capability, such as an IoT device, or whether the STA can support certain features such as MR-U or beamforming, for example. Without the ability to discern between types of STAs (e.g., IoT STA versus regular STA), an anchor wireless device (such as an access point, router, hub, or the like) cannot know how to most-efficiently interact with STAs of different capabilities. For example, either an entire feature set is available to a given STA or no feature in that feature set is available to the STA. Table 1 illustrates this approach with reference to a list of example STA features, where “M” stands for Mandatory.

TABLE 1

| | | Wi-Fi ® | Wi-Fi ® |
|---|---|---|---|
| | | MCS 7 20 | Regular |
| # | 20 MHz-only STA Feature | MHz-only STA | STA |
| 1 | MRU | Not Supported | M |
| 2 | DL MU-MIMO Full PPDU Bw Rx and | Not Supported | M |
| | BFee NDP Sounding Support for Total | | |
| | NSS <=4 | | |
| 3 | UL MU-MIMO Tx in non-OFDMA TB | Not Supported | M |
| | PDDU | | |
| 4 | DL SU Beamforming (STA Rx | Not Supported | M |
| | Support) | | |
| 5 | DL OFDMA with Beamforming (STA | Not Supported | M |
| | Rx Support) | | |
| 6 | DL Non-triggered based sounding (for | Not Supported | M |
| | SU Type Feedback) | | |
| 7 | DL Trigger based sounding for Full | Not Supported | M |
| | BW (for MU Type Feedback) | | |

For example, in current Modulation and Coding Scheme (MCS) protocol-based operation, all of the operational features listed in Table 1 are supported and available to a Wi-Fi® regular STA (e.g., with MCS 8 or 9), yet need not be supported by a Wi-Fi® MCS 7, 20 Megahertz (MHz)-only STA (e.g., an IoT device or limited-capability STA). As result, it has been challenging to know how a STA may unambiguously signal that the STA is a limited-capability, 20 MHz-only STA (such an IoT device), as opposed to being a regular STA that happens to be operating in a 20 MHz mode. Further, it has been challenging to increase granularity of feature selection for different STA types. For example, an IoT device in a smart home IoT segment could potentially have more complex features (e.g., need to support more functionality) compared to an IoT device in the wearables market, such as a smart watch. Former solutions involved the sometimes incorrect assumption that a wireless device communicating in a 20 MHz frequency band and with a maximum supported MCS of 7 was a limited-capability device such as an IoT device. This assumption was sometimes incorrect because some IoT or similar devices in the current market may support features only associated with higher MCS level, such as MCS 8 or MCS 9 (e.g., of which some are listed in Table 1).

To resolve these and other deficiencies with known approaches to signaling that a STA or client wireless device is of limited capability, according to disclosed embodiments, the present disclosure sets forth explicit STA signaling capabilities to indicate that a wireless device is a limited-capability IoT device and uncouple this capability from the maximum-supported MCS level. The current disclosure further discloses capability bits that may be read in combination to support signaling, at a greater granularity, various features relevant to the IoT market segment.

In at least some embodiments, a client wireless device initiates, e.g., via a front end, association of the wireless device with an anchor wireless device to communicate with the anchor wireless device. In some embodiments, the client wireless device transmits, to an anchor wireless device, management frames having a plurality of bits that specify PHY capabilities. This plurality of bits may include a particular bit that indicates whether the wireless device is an IoT device. In some embodiments, the plurality of bits also include an MCS bitmap that, together with the particular bit, indicate a particular MCS level at which the front end communicates. In some embodiments, the plurality of bits include a second bit that, in combination with the particular bit, specifies an IoT-related capability of the wireless device, e.g., M-RU support, multi-user beamforming, Orthogonal Frequency Division Multiple Access (OFDMA) uplink multi-user, multiple input, multiple output (MU-MIMO) support, among others that will be discussed.

The present disclosure includes a number of advantages, including the ability to unambiguously signal between a wireless STA and an anchor wireless device that the wireless STA is an IoT device and, if so, of what types of features or functionality the IoT device is capable. In this way, any given anchor wireless device can know precisely how to best and most-efficiently communicate with different wireless STAs. This brings significant power-saving, spectrum-saving, and other benefits in a wireless market of an increasing number of IoT devices of different capabilities. Additional advantages will be apparent to those skilled in the art of wireless STA configuration and communication are discussed further below.

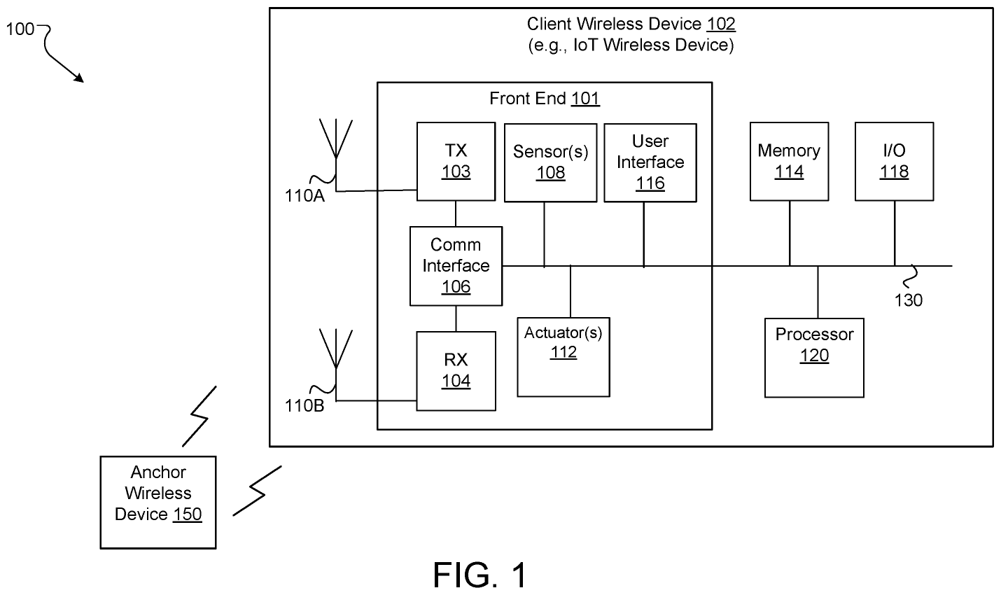

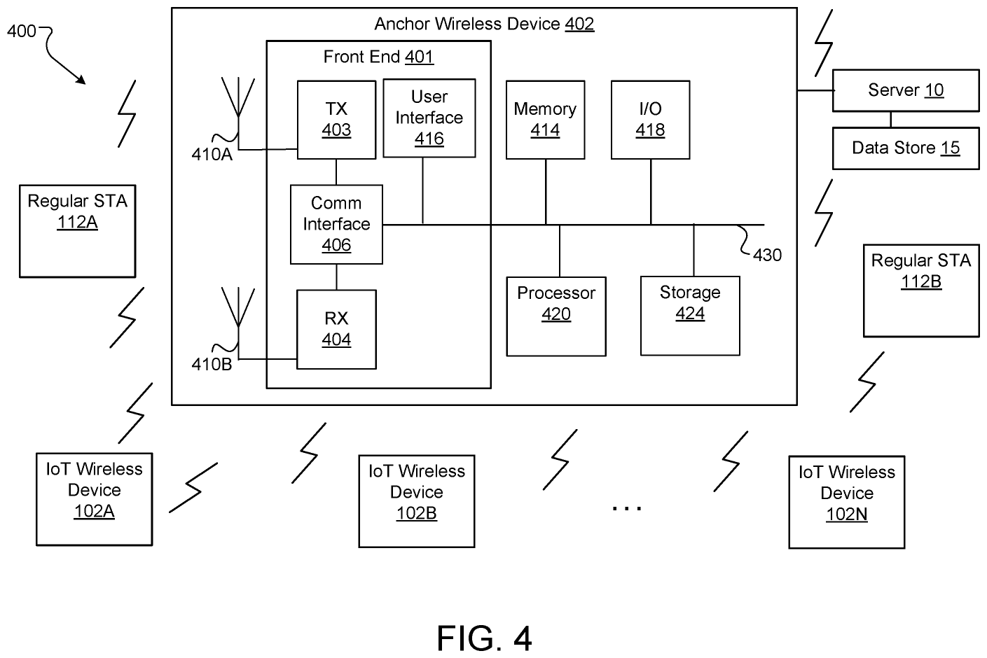

FIG. 1 is a block diagram of a wireless network 100 that includes an example client wireless device 102 of limited capability, such as an IoT wireless device, according to various embodiments. In some embodiments, the wireless network 100 includes an anchor wireless device 150 such as an access point (AP), hub, router, base station, or the like, through which the wireless device 102 may access a network, and ultimately, the Internet. An example of the anchor wireless device 150 will be discussed with reference to FIG. 4.

In at least some embodiments, the wireless device 102 includes, but is not be limited to, a front end 101, a transmit (TX) antenna 110A, a receive (RX) antenna 110B, a memory 114, input/output (I/O) circuitry 118, and a processor 120. In various embodiments, these components (except for the antennas) may be coupled to and adapted to communicate over a communications bus 130. In some embodiments, the TX antenna 110A and the RX antenna 110B may include multiple antennas to support beamforming and/or MU-MIMO or other such functionality that may require multiple antennas. In at least some embodiments, the front end 101 further includes hardware and logic intended to interface directly with the physical world.

For example, in some embodiments, the front end 101 includes, but is not limited to, a transmitter 103 or TX (e.g., a wireless local area network (WLAN) transmitter) coupled to the TX antenna 110A to transmit wireless signals, a receiver 104 or RX (e.g., a WLAN receiver) coupled to the RX antenna 110B to receive wireless signals, a communications interface 106, one or more sensors 108, one or more actuators 112, and a user interface 116. In some embodiments, the sensors 108 detect and respond to some type of input from the physical environment of the wireless device 102. The specific input could be light, heat (or temperature generally), motion, moisture, pressure, or any one of a great number of other environmental phenomena. The outputs of the sensors 108 are generally signals that are converted to human-readable display at the device or transmitted electronically over a network for reading or further processing. In some embodiments, the actuators 112 are the moving parts of a system that perform actions based on commands. They may be the counterpart to sensors; while the sensors 108 may convert physical parameters to electrical signals, the actuators 112 may convert electrical signals into physical movement or action. Examples of actuators 112 include motors, pumps, valves, and relays.

In some embodiments, aspects of the communication interface 106 work with the processor 120 to perform operations or that function as a processing device of the wireless device 102. In some embodiments, the communication interface 106 includes the modules and components that enable the wireless device 102 to communicate with the external world, which can be either other wireless devices and/or a central server (see FIG. 4). In some embodiments, the communication interface 106 may coordinate, as directed by the processor 120, to request/receive packets from other wireless devices or those that reflect off of objects. The communications interface 106 can further process data symbols received by the receiver 104 in a way that the processor 120 can perform further processing, including identifying and parsing data packets received within the wireless signals. In some embodiments, if the wireless device 102 (e.g., IoT device) is designed to interact with users, the front end 101 may also include the user interface 116 and include components such as buttons, light emitting diodes (LEDs), displays, touch screens, and the like.

In at least some embodiments, the memory 114 includes storage to store instructions executable by the processor 120 and/or data generated (or received) by the communication interface 106. In various embodiments, front end components such as the transmitter 103, the receiver 104, the communication interface 106, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-Wave™, Zigbee®, LoRa™, Wi-SUN®, or other wireless protocol, to include cellular protocol. While some of the protocols may also be referred to as personal area network (PAN) technology, for simplicity, all are broadly referred to as WLAN technology. While Wi-Fi® standards are explicitly referred to herein, the present disclosure may be applied to a range of different protocols, including possible future protocols, where the wireless device 102 associates with or attaches to a second wireless device (such as the anchor wireless device 150) for purposes of communication, e.g., via the use of management frames of equivalent frames that control PHY capability signaling.

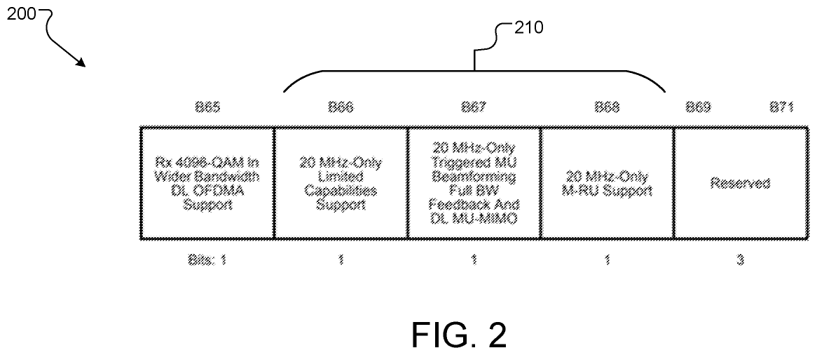

FIG. 2 is a block diagram of exemplary mapping 200 of multiple bits of management frames to be transmitted to an anchor wireless device to communicate feature set capability according to some embodiments. By way of example, a plurality of bits B65 through B71 were previously reserved bits of management frames in a previous Marketing Requirement Document (MRU) of IEEE 802.11be specification for PHY capabilities within the Wi-Fi® protocol. In some embodiments, at least a series of bits 210 (e.g., B66, B67, and B68) are devoted to signaling that a STA is an IoT device (e.g., a limited-capability and/or 20 MHz-only STA) in addition to signaling particular support for certain wireless communication features. In some embodiments, bits B69, B70, and/or B71 may also be employed as further bits to signal particular PHY-related capabilities.

For example, in some embodiments, a particular bit (e.g., bit B66 of the plurality of bits) of the management frames is employed to signal that a STA (e.g., the client wireless device 102) is an IoT device and capable of communicating only in a single channel of a 20 MHz bandwidth, e.g., and thus of limited bandwidth capability and/or of limited operational capability. In some embodiments, the plurality of bits employed within the management frames may also include an MCS bitmap that, together with the particular bit (e.g., bit B66), indicate a particular MCS level at which the front end 101 communicates. For example, the MCS level may be High Efficiency (HE), also associated with Wi-Fi® 6 (802.11ax), or Extremely High Throughput (EHT), also associated with Wi-Fi® 7 (802.11be), or other MCS level associated with an IoT, or limited-capability wireless device, e.g., that be designed or associated with a different wireless protocol than Wi-Fi®. If this particular bit (e.g., B66) is not asserted, a device communicating with that wireless device may assume the wireless device is in fact a wireless STA and capable of all operational features, e.g., consistent with MCS 8, MCS 9, or later MCS level.

In various embodiments, the plurality of bits include a second bit that, in combination with the particular bit (e.g., B66), specifies an IoT-related capability of the wireless device. For example, bits B68 and B66 may indicate the IoT-related capability includes multi-resource unit (M-RU) support. In some embodiments, Resource Units (RUs) are subdivisions of a channel in OFDMA (Orthogonal Frequency Division Multiple Access) transmissions, allowing multiple devices with varying bandwidth needs to be served simultaneously by dividing a channel into these smaller RUs (each of which may have a different bandwidth). For instance, in a 20 MHz channel, instead of one device taking up the entire bandwidth, the 20 MHz channel can be divided into different RUs, allowing simultaneous transmissions to multiple devices, each getting a portion (RU) of the channel. The “M” in M-RU implies that multiple such resource units may be used.

Further, by way of example, bits B67 with B66 may indicate a capability of multi-user (MU) beamforming with full bandwidth feedback and/or downlink multi-user, multiple input, multiple output support (MU-MIMO). This MU-MIMO may include additional hardware in the front end 101 that supports multiple channels of simultaneous communication.

Further, in some embodiments, the particular bit B66 and another bit (such as one of bits B69 through B71) may be employed to indicate a capability of non-orthogonal frequency division multiple access (non-OFDMA) uplink multi-user, multiple input, multiple output support. In other embodiments, the IoT-related capability being signaled by these bits may include, but not be limited to, downlink, single user beamformee support, downlink orthogonal frequency division multiple access (OFDMA) support, and/or uplink OFDMA support. In this way, the different bits of the plurality of bits from the management frames can be employed to provide a communication profile for different granularities for different types of wireless STAs, and in particular, those of limited capability that still have some higher-efficiency capabilities.

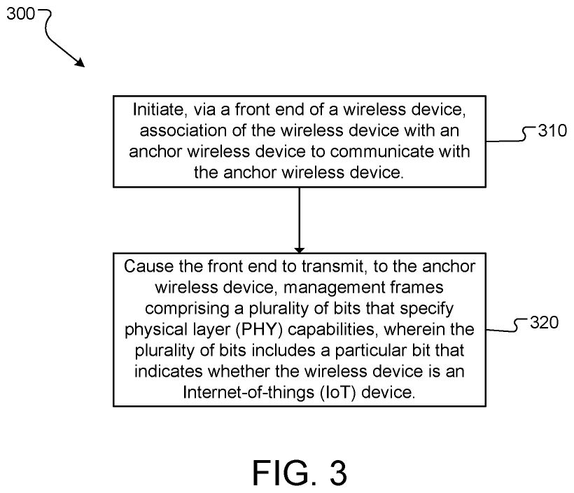

FIG. 3 is a flow chart of a method 300 for a client wireless device to communicate to the anchor wireless device 150 that the client wireless device is an IoT wireless device according to an embodiment. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the client wireless device 102, e.g., an IoT device in connection with the anchor device 150.

At operation 310, the processing logic initiates, via a front end of a wireless device, association of the wireless device with an anchor wireless device to communicate with the anchor wireless device. For example, the wireless device may be the client wireless device 102 or other IoT device of limited capability, as was discussed previously. Further, by way of example, the anchor wireless device may be an access point, router, hub, or other similar PAN-, LAN-, or WLAN-based wireless base station.

At operation 320, the processing logic causes the front end to transmit, to the anchor wireless device, management frames including a plurality of bits that specify physical layer (PHY) capabilities. In some embodiments, the plurality of bits includes a particular bit that indicates whether the wireless device is an Internet-of-things (IoT) device.

FIG. 4 is a block diagram of a wireless network 400 including an exemplary anchor wireless device 402 that communicates with different types of client wireless devices according to some embodiments. In some embodiments, the anchor wireless device 402 is the anchor wireless device 150 of FIG. 1. The wireless network 400 may further include one or more regular STAs 112A and 112B and one or more IoT wireless devices 102A-102N with which the anchor wireless device 150 communicates wirelessly, e.g., to provide network and/or Internet-based communication supports to these various STAs. In the wireless network 400 may further include a central server 10 having or coupled to a data store 15, e.g., stored in memory and/or storage of the server. In some embodiments, the server 10 is a Web server, a data server, or both.

In at least some embodiments, the anchor wireless device 402 includes, but is not limited to, a front end 401 coupled to a transmit (TX) antenna 410A and a receive (RX) antenna 410B, a memory 414, I/O circuitry 418 (and/or I/O devices), a processor 420, and a storage 424. All of these components may intercommunicate over a communications bus 430, which may also include control aspects. In some embodiments, the TX antenna 410A and the RX antenna 410B may include multiple antennas to support beamforming and/or MU-MIMO or other such functionality that may require multiple antennas.

In some embodiments, the front end 401 includes, but is not limited to, a transceiver that includes a transmitter 403 or TX (e.g., a WLAN transmitter) coupled to the TX antenna 410A and a receiver 404 or RX (e.g., a WLAN receiver) coupled to the RX antenna 410B. In some embodiments, the front end 401 further includes a communications interface 406 coupled to the transmitter 403 and the receiver 404 (e.g., of the transceiver) and a user interface 416 coupled to the communication interface 406 and other components of the anchor wireless device 402. In some embodiments, aspects of the communication interface 406 work with the processor 420 to perform operations or that function as a processing device of the anchor wireless device 402. In some embodiments, there is a single antenna and multiplexing logic to switch use of the antennas between the TX and RX. In some embodiments, the user interface 116 is configured to interface with users that may configure, adjust, or control the anchor wireless device, including components such as buttons, light emitting diodes (LEDs), displays, touch screens, and the like.

In some embodiments, aspects of the communication interface 406 work with the processor 420 to perform operations or that function as a processing device of the anchor wireless device 402. In some embodiments, the communication interface 406 includes the modules and components that enable the anchor wireless device 402 to communicate with the external world, which can be either other wireless devices and/or the central server 10. In some embodiments, the communication interface 406 may coordinate, as directed by the processor 120, to request/receive packets from other wireless devices or those that reflect off of objects. The communications interface 406 can further process data symbols received by the receiver 404 in a way that the processor 420 can perform further processing, including identifying and parsing data packets received within the wireless signals.

In at least some embodiments, the storage device 424 is non-volatile memory that stores instructions (such as software or firmware code) executable by the processor 420 and/or data generated by the communication interface 406. In some embodiments, the memory 414 is volatile memory (e.g., system memory) that supports the execution, by the processor, of subsets of the instructions and can also buffer data generated by the communication interface 406. In various embodiments, frontend components such as the transmitter 403, the receiver 404, the communication interface 406, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-Wave™, Zigbee®, LoRa™, Wi-SUN®, or other wireless protocol. While some of the protocols may also be referred to as personal area network (PAN) technology, for simplicity, all are broadly referred to as WLAN technology. Future protocols are also envisioned.

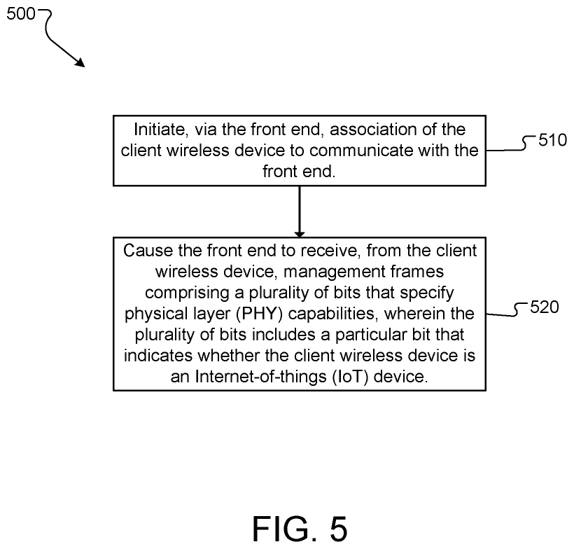

In some embodiments, the processor 420 (or a processing device) of the anchor wireless device is configured to initiate, via the front end 401, association of the client wireless device to communicate with the front end. The processor 420 may further cause the front end to receive, from the client wireless device 102, management frames including a plurality of bits that specify physical layer (PHY) capabilities. In some embodiments, the plurality of bits includes a particular bit that indicates whether the client wireless device is an Internet-of-things (IoT) device. In embodiments, the particular bit indicates that the client wireless device 102 communicates in a single channel of a 20 Megahertz (MHz) bandwidth. In some embodiments, the plurality of bits include a MCS bitmap that, together with the particular bit, indicate a particular MCS level at which the client wireless device communicates. In similar embodiments, as discussed with reference to FIGS. 1-3, the plurality of bits include a second bit that, in combination with the particular bit, specifies an IoT-related capability of the client wireless device. These features may also be supported by the method 500 of FIG. 5 in various embodiments.

FIG. 5 is a flow chart of a method 500 for an anchor wireless device to receive indication for the client wireless device that the client wireless device is an IoT wireless device according to some embodiments. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the anchor wireless device 402, e.g., processing logic of the anchor wireless device 150 and/or 402 in connection with anchor device hardware (see FIG. 1 and FIG. 4).

At operation 510, the processing logic initiates, via the front end, association of the client wireless device to communicate with the front end. This initiating may be started by the client wireless device, e.g., but typically is started by the anchor wireless device. For example, the anchor wireless devices may send out beacon frames (or other discovery request signals such as probe requests). Thus, in some embodiments, the client wireless device (or IoT device) may listen for the beacon frames and/or responds to the probe requests with probe responses. Other types of communication initiation are envisioned.

At operation 520, the processing logic causes the front end to receive, from the client wireless device, management frames comprising a plurality of bits that specify physical layer (PHY) capabilities, wherein the plurality of bits includes a particular bit that indicates whether the client wireless device is an Internet-of-things (IoT) device. The management frames, for example, may facilitate an information exchange in which the client wireless device communicates PHY capabilities such as channel widths, MCS level, MIMO configuration, number of spatial stream, and others discussed herein.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A wireless device comprising:
a front end; and
a processor coupled to the front end, wherein the processor is to:
initiate, via the front end, association of the wireless device with an anchor wireless device to communicate with the anchor wireless device; and
cause the front end to transmit, to the anchor wireless device, management frames comprising a plurality of bits that specify physical layer (PHY) capabilities, wherein the plurality of bits includes a particular bit that indicates whether the wireless device is an Internet-of-things (IoT) device.

2. The wireless device of claim 1, wherein the particular bit indicates that the front end communicates in a single channel of a 20 Megahertz (MHz) bandwidth.

3. The wireless device of claim 1, wherein the plurality of bits include a modulation and coding scheme (MCS) bitmap that, together with the particular bit, indicate a particular MCS level at which the front end communicates.

4. The wireless device of claim 1, wherein the plurality of bits include a second bit that, in combination with the particular bit, specifies an IoT-related capability of the wireless device.

5. The wireless device of claim 4, wherein the IoT-related capability comprises multi-resource unit (M-RU) support.

6. The wireless device of claim 4, wherein the IoT-related capability comprises at least one of:
multi-user beamforming with full bandwidth feedback; or
downlink multi-user, multiple input, multiple output support.

7. The wireless device of claim 4, wherein the IoT-related capability comprises non-orthogonal frequency division multiple access (non-OFDMA) uplink multi-user, multiple input, multiple output support.

8. The wireless device of claim 4, wherein the IoT-related capability comprises at least one of:
downlink, single user beamformee support;
downlink orthogonal frequency division multiple access (OFDMA) support; or
uplink OFDMA support.

9. A method comprising:
initiating, via a front end of a wireless device, association of the wireless device with an anchor wireless device to communicate with the anchor wireless device; and
causing the front end to transmit, to the anchor wireless device, management frames comprising a plurality of bits that specify physical layer (PHY) capabilities, wherein the plurality of bits includes a particular bit that indicates whether the wireless device is an Internet-of-things (IoT) device.

10. The method of claim 9, wherein the particular bit indicates that the front end communicates in a single channel of a 20 Megahertz (MHz) bandwidth.

11. The method of claim 9, wherein the plurality of bits include a modulation and coding scheme (MCS) bitmap that, together with the particular bit, indicate a particular MCS level at which the front end communicates.

12. The method of claim 9, wherein the plurality of bits include a second bit that, in combination with the particular bit, specifies an IoT-related capability of the wireless device.

13. The method of claim 12, wherein the IoT-related capability comprises multi-resource unit (M-RU) support.

14. The method of claim 12, wherein the IoT-related capability comprises at least one of:
multi-user beamforming with full bandwidth feedback; or
downlink multi-user, multiple input, multiple output support.

15. The method of claim 12, wherein the IoT-related capability comprises non-orthogonal frequency division multiple access (non-OFDMA) uplink multi-user, multiple input, multiple output support.

16. The method of claim 12, wherein the IoT-related capability comprises at least one of:
downlink, single user beamformee support;
downlink orthogonal frequency division multiple access (OFDMA) support; or
uplink OFDMA support.

17. An anchor wireless device comprising:
a front end to wirelessly communicate with a client wireless device; and
a processor coupled to the front end, the processor to:
initiate, via the front end, association of the client wireless device to communicate with the front end; and
cause the front end to receive, from the client wireless device, management frames comprising a plurality of bits that specify physical layer (PHY) capabilities, wherein the plurality of bits includes a particular bit that indicates whether the client wireless device is an Internet-of-things (IoT) device.

18. The anchor wireless device of claim 17, wherein the particular bit indicates that the client wireless device communicates in a single channel of a 20 Megahertz (MHz) bandwidth.

19. The anchor wireless device of claim 17, wherein the plurality of bits include a modulation and coding scheme (MCS) bitmap that, together with the particular bit, indicate a particular MCS level at which the client wireless device communicates.

20. The anchor wireless device of claim 17, wherein the plurality of bits include a second bit that, in combination with the particular bit, specifies an IoT-related capability of the client wireless device.
